(19) United States
(12) Patent Application Publication
(10) Pub. No.: US 2011/0186152 A1
(43) Pub. Date: Aug. 4, 2011

(54) Compact Flow-Through Fuel Pressure Regulator

(75) Inventor: Juvenal Herrera, Newport News, VA (US)

(73) Assignee: CONTINENTAL AUTOMOTIVE SYSTEMS US, INC., Auburn Hills, MI (US)

(21) Appl. No.: 12/696,073

(22) Filed: Jan. 29, 2010

(51) Int. Cl. F16K 15/00

(52) U.S. Cl. 137/535

(57) ABSTRACT

A compact pressure regulator (10′) has a body (20′) having a fuel inlet (23) and a fuel outlet (25) defining a fuel chamber (22′). A valve seat (24′) is defined in the body at the fuel outlet. A valve element (26′) is movable between open and closed positions and has a seating surface (36) that engages the valve seat in the closed position. A housing (46) has a proximal end (56) coupled to the body with a distal end (58) of the body having a housing fuel outlet (60). A coil compression spring (40) is disposed between the valve element and the housing and is constructed and arranged to bias the valve element to the closed position. The valve element includes a spring engaging surface (50) that engages one end of the spring and the housing includes spring retaining structure (44) engaging the other end of the spring.

### FIELD OF THE INVENTION

The invention relates to fuel supply systems and, more particularly, to a compact flow-through fuel pressure regulator for directing flow of fuel within the fuel system.

### BACKGROUND OF THE INVENTION

Most modern automotive fuel systems use fuel injectors to deliver fuel to the engine cylinders for combustion. The fuel injectors are mounted on a fuel rail to which fuel is supplied by a fuel pump. The pressure at which the fuel is supplied to the fuel rail must be metered to ensure the proper operation of the fuel injector. Metering is carried out by using a pressure regulator that controls the pressure of the fuel in the system at all engine RPM levels.

With reference to FIG. 1, a typical construction of pressure regulator of the type disclosed in U.S. Patent Publication No. 2006/0108007 A1 is shown, generally indicated at 10. The regulator 10 includes a fuel tube body 20 defining a fuel chamber 22 that channels fuel into the pressure regulator 10 from fuel pump (not shown). The body 20 includes a valve seat 24 that cooperates with a valve element 26. Valve element 26 is movably disposed between closed and open positions. In the closed position, the valve element contacts the valve seat 24 in a sealing manner preventing fuel flow past the valve seat. The valve element 26 is biased into the closed position by a disk-type spring 28 which is held in place by crimping an edge thereof to a housing 30. Pressurized fuel flows into and accumulates in the tube 22 and contacts the bottom of the valve element. When the fuel pressure is sufficient to overcome the biasing force of spring 28, the pressurized fuel will push the valve element 26 off the valve seat 24 into the open position. Fuel then flows past the valve seat 24 and though fuel outlets 32 in cover 34.

While such pressure regulators have been proven satisfactory, they require either a great number of parts or large parts.

Thus, there is a need to provide an improved fuel pressure regulator with fewer and smaller parts than conventional regulators to reduce the material and manufacturing costs thereof.

### SUMMARY OF THE INVENTION

An object of the present invention is to fulfill the need referred to above. In accordance with the principles of an embodiment, this objective is obtained by providing a flow-through pressure regulator including a body having a fuel inlet and a fuel outlet and defining a fuel chamber there-between. A valve seat is defined in the body generally at the fuel outlet. A valve element is movable between open and closed positions. The valve element has a seating surface that engages the valve seat in the closed position to prevent fuel from passing through the fuel outlet. A housing has a proximal end coupled to the body. A distal end of the housing has at least one housing fuel outlet therein. A coil compression spring has first and second ends. The spring is disposed between the valve element and the housing and is constructed and arranged to bias the valve element to the closed position in opposition to pressure exerted on the valve element by fuel in the fuel chamber. The valve element includes a spring engaging surface that engages one end of the spring and the housing includes spring retaining structure engaging the other end of the spring. The spring is constructed and arranged to permit the valve element to move from engagement with the valve seat to the open position thereof when a certain pressure builds in the fuel chamber, thereby permitting the fuel outlet of the body to communicate with the housing fuel outlet.

Other objects, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification.

### BRIEF DESCRIPTION OF THE DRAWINGS

The invention will be better understood from the following detailed description of the preferred embodiments thereof, taken in conjunction with the accompanying drawings, wherein like reference numerals refer to like parts, in which:

FIG. 1 is a sectional view of a conventional fuel pressure regulator.

FIG. 2 is a sectional view of a fuel pressure regulator provided in accordance with an embodiment of the present invention.

### DETAILED DESCRIPTION OF THE EXEMPLARY EMBODIMENTS

Referring to FIG. 2, a fuel pressure regulator is shown, generally indicated at 10′, in accordance with an embodiment of the present invention. The regulator 10′ is preferably used in automotive fuel systems, particularly in fuel delivery modules. The regulator 10′ includes a generally cylindrical fuel tube body 20′ defining a fuel chamber 22′ that receives fuel that enters a fuel inlet 23 of the body 20′ delivered by a fuel pump (not shown). The body 20′ includes a valve seat 24′ at a fuel outlet 25 of the body 20′. The valve seat 24′ cooperates with a valve element 26′.

Valve element 26′ is preferably a half-spherical member having a convex seating surface 36 that selectively engages the valve seat 24′. In particular, sealing surface 38 that defines the valve seat 24′ is preferably a concave annular surface, coined into the body 20′ by a forming member or by the valve element 26′. The sealing surface 38 mates with the convex seating surface 36 of the valve element 26′ in a closed position thereof preventing fuel flow past the valve seat 24′. The valve element 26′ is biased into the closed position by a compression spring 40, preferably a coil spring, that is held in place at one end 42 thereof by spring retaining structure, preferably in the form of a detent 44 in a housing 46 of the regulator 10′. The detent 44 extends towards the valve element 26′.

As shown in FIG. 2, the half-spherical valve element 26′ includes a generally cylindrical cut-out 48 defining a spring engaging surface as a flat surface 50. End 52 of the spring 40 engages the flat surface 50. Sidewall 54 and flat surface 50 define an interior portion 51 of valve element 26′ and help align and guide the portion of the spring 40 that is in the interior portion 51. Flat surface 50 can remain unfinished (have no surface finish) to reduce manufacturing cost. As shown in FIG. 2, detent 44, spring 40 and valve element 26′ are aligned along common axis A.

The generally cylindrical housing 46 is fixedly coupled at proximal end 56 thereof to an outer periphery of the tube body 20′. Thus, the body 20′ and the housing 46 are aligned along common axis A. The proximal end 56 of the housing 46 is an open end. A distal end 58 of the housing 46 is a generally closed end that includes at least one housing fuel outlet 60 therein. Thus housing 46 defines a chamber 57 that encloses the spring 40. Chamber 57 communicates with the fuel chamber 22′ when the valve element 26′ is in the open position.

Pressurized fuel flows into and accumulates in the fuel chamber 22′ and contacts the surface 36 of the valve element 26′. When the fuel pressure is sufficient to overcome the biasing force of spring 40, the pressurized fuel will push the valve element 26′ off the valve seat 24′ into the open position. Fuel then flows through the fuel outlet 25 of the body 20′ and through the housing fuel outlets 60 in housing 46.

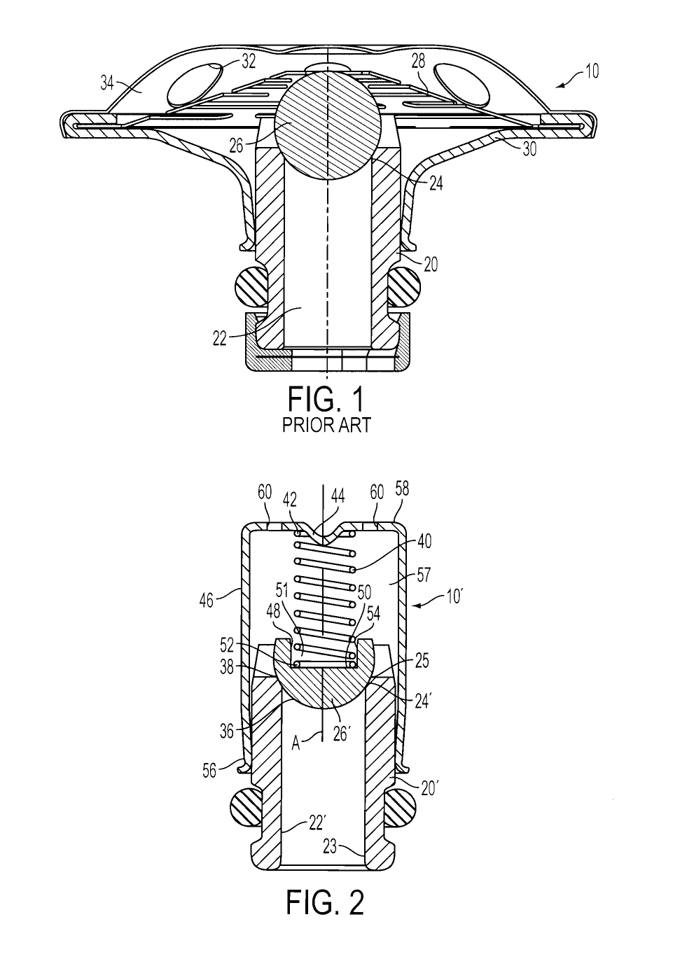

The pressure regulator 10′ does not require a spring cover as does the regulator 10 of FIG. 1. Furthermore, the regulator 10′ uses a compact, simple coil spring instead of the large disk spring of regulator 10. Thus, the regulator 10′ is more compact and less expensive to manufacture than the regulator 10.

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the spirit of the following claims.

What is claimed is:

1. A flow-through pressure regulator comprising:
a body having a fuel inlet and a fuel outlet and defining a fuel chamber there-between,
a valve seat defined in the body generally at the fuel outlet,
a valve element movable between open and closed positions, the valve element having a seating surface that engages the valve seat in the closed position to prevent fuel from passing through the fuel outlet,
a housing having a proximal end coupled to the body, a distal end of the housing having at least one housing fuel outlet therein, and
a coil compression spring having first and second ends, the spring being disposed between the valve element and the housing and being constructed and arranged to bias the valve element to the closed position in opposition to pressure exerted on the valve element by fuel in the fuel chamber,
the valve element including a spring engaging surface that engages one end of the spring and the housing includes a spring retaining structure engaging the other end of the spring,
wherein the spring is constructed and arranged to permit the valve element to move from engagement with the valve seat to the open position thereof when a certain pressure builds in the fuel chamber, thereby permitting the fuel outlet of the body to communicate with the housing fuel outlet.

2. The regulator of claim 1, wherein the valve element, spring and spring retaining structure are aligned along a common axis.

3. The regulator of claim 1, wherein the valve element is a half-spherical member with the seating surface being a convex surface, the half-spherical member including a cut-out therein defining the spring engaging surface as a flat surface.

4. The regulator of claim 3, wherein the cut-out is generally cylindrical having a sidewall defining, together with the flat surface, an interior portion of the valve element, a portion of the spring being disposed in the interior portion.

5. The regulator of claim 2, wherein the spring retaining structure is a detent in the housing.

6. The regulator of claim 5, wherein the detent extends towards the valve element.

7. The regulator of claim 1, wherein both the housing and the body are generally cylindrical and are aligned along a common axis.

8. The regulator of claim 1, wherein the proximal end of the housing is an open end and the distal end of the housing is a generally closed end.

9. The regulator of claim 1, wherein the valve seat is defined by a concave sealing surface that mates with the convex seating surface of the valve element in the closed position.

10. A flow-through pressure regulator comprising:
a body having a fuel inlet and a fuel outlet and defining a fuel chamber there-between,
a valve seat defined in the body generally at the fuel outlet,
a valve element movable between open and closed positions, the valve element having a seating surface that engages the valve seat in the closed position to prevent fuel from passing through the fuel outlet,
a housing having a proximal end coupled to the body, a distal end of the housing having at least one housing fuel outlet therein, and
a coil compression spring having first and second ends, the spring being disposed between the valve element and the housing and being constructed and arranged to bias the valve element to the closed position in opposition to pressure exerted on the valve element by fuel in the fuel chamber,
the valve element including a flat spring engaging surface that engages one end of the spring and the housing includes a detent engaging the other end of the spring,
wherein the spring is constructed and arranged to permit the valve element to move from engagement with the valve seat to the open position thereof when a certain pressure builds in the fuel chamber, thereby permitting the fuel outlet of the body to communicate with the housing fuel outlet.

11. The regulator of claim 10, wherein the valve element, spring and detent are aligned along a common axis.

12. The regulator of claim 10, wherein the valve element is a half-spherical member with the seating surface being a convex surface, the half-spherical member including a cut-out therein defining the flat spring engaging surface.

13. The regulator of claim 12, wherein the cut-out is generally cylindrical having a sidewall defining, together with the flat spring engaging surface, an interior portion of the valve element, a portion of the spring being disposed in the interior portion.

14. The regulator of claim 10, wherein the detent extends towards the valve element.

15. The regulator of claim 10, wherein both the housing and the body are generally cylindrical and are aligned along a common axis.

16. The regulator of claim 10, wherein the proximal end of the housing is an open end and the distal end of the housing is a generally closed end.

17. The regulator of claim 10, wherein the valve seat is defined by a concave sealing surface that mates with the convex seating surface of the valve element in the closed position.
